(19) United States
(12) Patent Application Publication
(10) Pub. No.: US 2012/0015601 A1
(43) Pub. Date: Jan. 19, 2012

(54) RADIO COMMUNICATION SYSTEM, RELAY DEVICE, CONTROL DEVICE, AND COMMUNICATION METHOD

(75) Inventor: Masafumi TSUTSUI, Kawasaki (JP)

(73) Assignee: FUJITSU LIMITED, Kawasaki-shi (JP)

(21) Appl. No.: 13/181,784

(22) Filed: Jul. 13, 2011

(30) Foreign Application Priority Data
Jul. 15, 2010 (JP) 2010-160471

(51) Int. Cl. H04B 7/14

(52) U.S. Cl. 455/7

(57) ABSTRACT

A radio communication system including a first communication device configured to transmit a signal, a relay device which includes a receiver configured to receive the transmitted signal, an amplifier configured to amplify the received signal according to a gain determined by a processor included in a control device, and a transmitter configured to transmit the amplified signal to a second communication device, the second communication device being configured to receive the amplified signal, and the transmitted signal, which is transmitted directly from the first communication device, and the control device being configured to improve a reception quality of the amplified signal and the directly transmitted signal.

### CROSS-REFERENCE TO RELATED APPLICATIONS

This application is based upon and claims the benefit of priority from the prior Japanese Patent Application No. 2010-160471 filed on Jul. 15, 2010, the entire contents of which are incorporated herein by reference.

### FIELD

The embodiments discussed herein are related to a relay device that relays radio communication between communication devices, a control device that controls a relay device, a radio communication system, and a communication method in the radio communication system.

### BACKGROUND

A radio communication system of a mobile phone or the like has been designed to allocate radio base stations in such a way that a mobile terminal performs radio communication with at least one of the radio base stations. However, even if a plurality of radio base stations are allocated, there is a dead spot in which the mobile terminal is unable to perform the radio communication with any of the plurality of radio base stations due to geological restriction, shade of buildings, or the like. Therefore, there has been a proposal of the allocation of a relay device (e.g., a repeater) to eliminate the dead spot and establish the radio communication between the mobile terminal and the radio base station. The relay device receives a signal transmitted from the radio base station and then transmits the signal to the mobile terminal after amplifying the received signal. Alternatively, the relay device receives a signal transmitted from the mobile terminal and then transmits the signal to the base station after amplifying the received signal. The technique related to the radio communication through the relay device is described in, for example, Japanese Laid-open Patent Publication No. 2005-229524, Japanese National Publication of International Patent Application No. 2007-500482, and Japanese Laid-open Patent Publication No. 2007-251924.

### SUMMARY

According to an aspect of the invention, a radio communication system includes a first communication device configured to transmit a signal, a relay device which includes a receiver configured to receive the transmitted signal, an amplifier configured to amplify the received signal according to a gain determined by a processor included in a control device, and a transmitter configured to transmit the amplified signal to a second communication device, the second communication device being configured to receive the amplified signal, and the transmitted signal, which is transmitted directly from the first communication device, and the control device being configured to improve a reception quality of the amplified signal and the directly transmitted signal.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an example of a configuration of a radio communication system according to an embodiment;

FIG. 2 is a block diagram illustrating a configuration of a repeater according to the embodiment;

FIG. 3 is a block diagram illustrating a configuration of a control device according to the embodiment;

FIG. 4 is a sequence diagram illustrating an example of a flow of an operation of the radio communication system according to the embodiment;

FIG. 5 is a flowchart illustrating an example of the flow of the operation of the radio communication system according to the embodiment; and

FIG. 6 is a graph illustrating a mode of improvement of a reception quality of a mobile terminal obtained by determination of a grain setting value by a gain determining unit.

### DESCRIPTION OF EMBODIMENTS

An amplification rate (that is, a gain) of the signal in the relay device is controlled to have an appropriate value from a viewpoint of suppression of oscillation caused by expansion of the relay area where a signal is relayed (transmitted, in other words) by the relay device or a sneak of radio waves. The sneak of radio waves, which may also be called e.g., a feedback signal or a self interference, expresses a phenomenon that a relay device receives a signal transmitted the relay device itself which may result in causing interference. However, even if the gain is adjusted from the viewpoint of suppression of oscillation caused by the expansion of the relay area by the relay device or the sneak of radio waves, improvement of the reception quality in the mobile terminal may not always be achieved. For example, the reception quality in the receiver may deteriorate when a signal directly transmitted from the radio base station to the mobile terminal interferes with a signal transmitted to the mobile terminal through the relay device. The above-described technical problem may occur with respect to not only the radio communication system using a mobile phone, but also to the relay device that relays the radio communication between communication devices in other communication systems.

With reference to the diagrams, embodiments of the present application will be described below. A mobile phone system will be described below as an example of a radio communication system. The embodiments described below are applicable to various radio communication systems other than the mobile phone system.

(1) Configuration of Radio Communication System

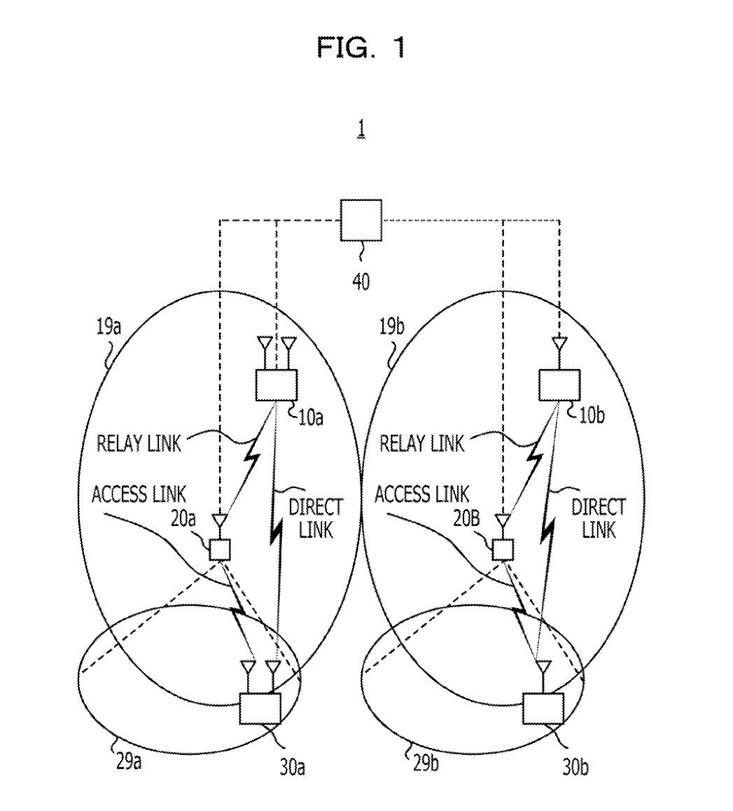

With reference to FIG. 1, a configuration of a radio communication system 1 according to the embodiment will be described. FIG. 1 is a block diagram illustrating an example of the configuration of the radio communication system 1 according to the embodiment.

As illustrated in FIG. 1, the radio communication system 1 according to the embodiment includes a radio base station 10a, a radio base station 10b, a cell 19a, a cell 19b, a repeater 20a, a repeater 20b, a relay area 29a, a relay area 29b, a mobile terminal 30a, a mobile terminal 30b, and a control device 40. The number of radio base stations 10, repeaters 20, mobile terminals 30, and control devices 40 illustrated in FIG. 1 is an example. The number of the radio base stations 10, the repeaters 20, the mobile terminals 30, and the control devices 40 is not limited to the number illustrated in FIG. 1. Hereinafter, in a description without distinguishing between the radio base station 10a and the radio base station 10b, the radio base station 10a and the radio base station 10b are referred to as a “radio base station 10.” Similarly, in a description without distinguishing between the repeater 20a and the repeater 20b, the repeater 20a and the repeater 20b are referred to as a “repeater 20.” Similarly, in a description without distinguishing between the mobile terminal 30a and the mobile terminal 30b, the mobile terminal 30a and the mobile terminal 30b are referred to as a “mobile terminal 30.”

The radio base station 10 covers a cell 19 (that is, a macrocell) of which the radius is approximately several kilometers to more than ten kilometers, or several tens of kilometers, for example. The radio base station 10 performs radio communication between the repeater 20 positioned inside the cell 19, which is covered by the radio base station 10, and the mobile terminal 30. That is, the radio base station 10 establishes communication connection between the repeater 20 positioned inside the cell 19, which is covered by the radio base station 10, and the mobile terminal 30 and then transmits and receives various signals to and from the repeater 20 and the mobile terminal 30.

When transmitting various signals from the radio base station 10 to the mobile terminal 30 (that is, when performing communication in a downlink direction), the radio base station 10 is an example of a “first communication device.” On the other hand, when receiving the various signals transmitted from the mobile terminal 30 (that is, when performing communication in an uplink direction), the radio base station 10 is an example of a “second communication device.”

According to the present embodiment, the radio communication system 1 includes the radio base station 10a, which has a plurality of antennas (that is, a radio base station that performs Multiple Input Multiple Output (MIMO) communication) and the radio base station 10b, which has a single antenna (that is, the radio base station 10b that performs Single Input Single Output (SISO) communication), as the radio base station 10. The radio communication system 1 may be unlikely to include the radio base station 10a, which has the plurality of antennas, or the radio base station 10b, which has the single antenna. The radio base station 10a having the plurality of antennas may transmit and receive the various data streams by using the plurality of antennas. Alternatively, the radio base station 10a having the plurality of antennas may redundantly transmit and receive a similar data stream by using the plurality of antennas. On the other hand, the radio base station 10b having a single antenna may transmit and receive a single data stream by using the single antenna.

The above-description illustrates the radio base station 10 that covers the cell 19 (that is, a macrocell) of which the radius is approximately several kilometers to more than ten kilometers, or several tens of kilometers, for example. In addition to or instead of e Node B (eNB) 10, a radio base station that covers the cell (that is, a micro cell) of which the radius is approximately several hundred kilometers to 1 kilometer or a radio base station that covers the cell (that is, a femtocell) of which the radius is approximately a few meters to more than ten meters or several tens of meters, for example. Various radio base stations that cover the cells other than the cell of which the radius has the above-described size may also be allocated.

The repeater 20, for example as a “relay device,” relays a radio wave from the radio base station 10 to the mobile terminal 30 inside the relay area 29, which is covered by the repeater 20, and relays the radio wave from the mobile terminal 30 inside the relay area 29 to the radio base station 10. Due to this, the size and the shape of the cell 19 covered by the radio base station 10 is substantially expanded or deformed. For example, as illustrated in FIG. 1, the repeater 20a relays the radio wave from the radio base station 10a to the mobile terminal 30a inside the relay area 29a, which is covered by the repeater 20a, and relays the wave radio from the mobile terminal 30a inside the relay area 29a to the radio base station 10a. Similarly, as illustrated in FIG. 1, the repeater 20b relays the radio wave from the mobile base station 10b to the mobile terminal 30b inside the relay area 29b, which is covered by the repeater 20b, and relays the radio wave from the mobile terminal 30b inside the relay area 29b to the radio base station 10b. In the present embodiment, a radio link between the radio base station 10 and the repeater 20 is referred to as a relay link, the radio link between the repeater 20 and the mobile terminal 30 is referred to as an access link, and the radio link between the radio base station 10 and the mobile terminal 30 is referred to as a direct link.

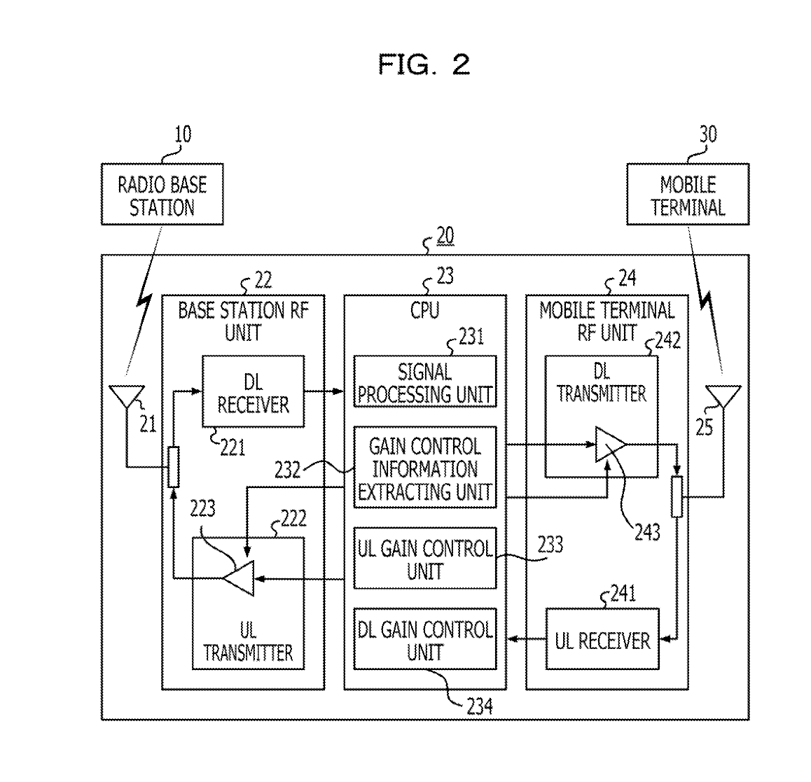

According to the present embodiment, the repeater 20 may include a single base station antenna 21 (see FIG. 2), which is used to perform the radio communication with the radio base station 10, and a single mobile terminal antenna 25 (see FIG. 2), which is used to perform the radio communication with the mobile terminal 30. However, the repeater 20 may include a plurality of base station antennas 21, which is used to perform the radio communication with the radio base station 10, and include a plurality of mobile terminal antennas 25, which is used to perform the radio communication with the mobile terminal 30.

As with the radio base station 10, the allocation position of the repeater 20 may be fixed. Alternatively, the allocation position of the repeater 20 is movable. For example, the repeater 20 may be allocated in a mobile object such as a car, a train, an airplane, and a ship.

The mobile terminal 30 establishes a connection with the radio base station 10 corresponding to the cell 19 positioned inside thereof or the repeater 20 corresponding to the relay area 29 in which the mobile terminal 30 is positioned inside thereof, and transmits and receives signals. The mobile terminal 30 may use various services and applications (for example, mail service, voice communication service, WEB browsing service, packet communication service, and the like) through the radio base station 10 (furthermore, an upper node to be coupled to an upper order of the radio base station 10). A mobile phone, a Personal Digital Assistant (PDA), various information apparatuses with radio communication functions are given as an example of the mobile terminal 30.

When transmitting various signals to the radio base station 10 from the mobile terminal 30 (that is, when performing the communication in the uplink direction), the mobile terminal 30 is an example of the “first communication device.” On the other hand, when receiving the various signal transmitted from the radio base station 10 (that is, when performing the communication in the downlink direction), the mobile terminal 30 is an example of the “second communication device.”

According to the present embodiment, the radio communication system 1 includes the mobile terminal 30a, which has a plurality of antennas (that is, the mobile terminal 30a that performs the MIMO communication), and the mobile terminal 30b, which has a single antenna (that is, the mobile terminal 30b that performs the SISO communication), as the mobile terminal 30. The mobile terminal 30a, which performs the MIMO communication, receives the data stream (direct data stream) transmitted through the direct link and the data stream (relay data stream) through the relay link and the access link. Specifically, the mobile terminal 30a obtains a reception signal obtained by spatially multiplexing the direct data stream and the relay data stream. Therefore, by using a Zero Forcing (ZF) decoder, a Minimum Mean Square Error (MMSE) decoder, an Ordered Successive Interference Cancellation (OSIC) decoder, and the like, the mobile terminal 30a may separate each data stream from the reception signal that is spatially multiplied.

The radio communication system 1 may include either the mobile terminal 30a having the plurality of antennas or the mobile terminal 30b having the single antenna. By using the plurality of antennas, the mobile terminal 30a having the plurality of antennas may transmit and receive different data streams to and from the radio base station 10a having the plurality of antennas and the radio base station 10b having the single antenna. Alternatively, by using the plurality of antennas, the mobile terminal 30a having the plurality of antennas may redundantly transmit and receive the similar data stream to and from the radio base station 10a having the plurality of antennas or to and from the radio base station 10b having the single antenna. On the other hand, by using the single antenna, the mobile terminal 30b having the single antenna may transmit and receive a single data stream to and from the radio base station 10a having the plurality of antennas or to and from the radio base station 10b having the single antenna. In the example illustrated in FIG. 1, by using the mobile terminal 30a having the plurality of antennas transmits and receives different data streams to and from the radio base station 10a having the plurality of antennas. That is, the mobile terminal 30a performs the MIMO communication with the radio base station 10a. In the example illustrated in FIG. 1, by using the single antenna, the mobile terminal 30b with the single antenna transmits and receives the single data stream to and from the radio base station 10b having the single antenna. That is, the mobile terminal 30b performs the SISO communication with the radio base station 10b.

The control device 40 controls operations of the repeater 20. According to the present embodiment, based on the reception quality or the like of the mobile terminal 30, the control device 40 adjusts a gain of an amplifier 223 and an amplifier 243 included in the repeater 20 (see FIG. 2). The details of the adjustment of the gain by the control device 40 will be described below.

The control device 40 may be independent from the radio base station 10, the repeater 20, and the mobile terminal 30. Alternatively, the control device 40 may be assembled inside the radio base station 10, may be assembled inside the repeater 20, or may be assembled inside the mobile terminal 30, for example.

(2) Configuration of Repeater

With reference to FIG. 2, a configuration of the repeater 20 according to the present embodiment will be described. FIG. 2 is a block diagram illustrating the configuration of the repeater 20 according to the present embodiment.

As illustrated in FIG. 2, the repeater 20 includes a base station antenna 21, a base station Radio Frequency (RF) unit 22, a Central Processing Unit (CPU) 23, a mobile terminal RF unit 24, and a mobile terminal antenna 25.

The base station antenna 21 receives a downlink signal transmitted from the radio base station 10 through the relay link and then outputs the received downlink signal to the base station RF unit 22. The base station antenna 21 transmits an uplink signal output from the base station RF unit 22 to the radio base station 10 through the relay link.

The base station RF unit 22 includes a Down Link (DL) receiver 221 as an example of the “receiver,” and an Up Link (UL) transmitter 222 as an example of the “transmitter.”

When receiving the downlink signal through the base station antenna 21, the DL receiver 221 performs radio transmitting/receiving processing on the downlink signal received by the base station antenna 21. The DL receiver 221 outputs the downlink signal subjected to the radio transmitting/receiving processing to the mobile terminal RF unit 24 through the CPU 23 or without using the CPU 23.

When transmitting the uplink signal through the base station antenna 21, the UL transmitter 222 performs the radio transmitting/receiving processing on the uplink signal output from the mobile terminal RF unit 24 through the CPU 23 or without using the CPU 23. For example, the UL transmitter 222 performs amplifying processing on the uplink signal by the amplifier 223 provided inside thereof. The amplifier 223 performs the amplifying processing on the uplink signal according to a gain set by the UL gain control unit 233. The UL transmitter 222 outputs the uplink signal subjected to the radio transmitting/receiving processing and the amplifying processing to the base station antenna 21.

The CPU 23 is, for example, a central processing device that controls the entire operation of the repeater 20 based on a prescribed firmware. The CPU 23 includes a signal processing unit 231, a gain control information extracting unit 232, a UL gain control unit 233, and a DL gain control unit 234 as a processing block that is functional, physical, or logical and is provided inside the CPU 23.

The signal processing unit 231 performs appropriate signal processing on various signals transmitted and received between the base station RF unit 22 and the mobile terminal RF unit 24. For example, if the repeater 20 is an Amplify and Forward type repeater 20, the signal processing unit 231 may transmit various signals, which are transmitted and received between the base station RF unit 22 and the mobile terminal RF unit 24, to the mobile terminal RF unit 24 from the base station RF unit 22 or to the base station RF unit 22 from the mobile terminal RF unit 24. Alternatively, if the repeater 20 is a Decode and Forward type repeater 20, the signal processing unit 231 may perform processing related to a layer 1 (for example, demodulating processing, decoding processing, coding processing, or modulating processing), processing related to a layer 2 (for example, Media Access Control (MAC) processing, Radio Link Control (RLC) processing, Packet Data Convergence Protocol (PDCP) processing, or the like), processing related to a layer 3 (for example, Radio Resource Control (RRC) processing or the like), or processing related to an application.

The gain control information extracting unit 232 extracts each gain setting value of the amplifier 223 and the amplifier 243 from among the control signals transmitted from the control device 40 to the repeater 20 through the radio base station 10. The gain control information detecting unit 232 outputs the extracted gain setting value to the UL gain control unit 233 and the DL gain control unit 234, respectively.

The UL gain control unit 233 sets the gain of the amplifier 223 to the gain setting value (specifically, the gain setting value with respect to the amplifier 223) that is output from the gain control information extracting unit 232.

The DL gain control unit 234 sets the gain of the amplifier 243 to the gain setting value (specifically, the gain setting value with respect to the amplifier 243) that is output from the gain control information extracting unit 232.

The mobile terminal RF unit 24 includes a UL receiver 241 as an example of the “receiver,” and a DL transmitter 242 as an example of the “transmitter.”

When receiving the uplink signal through the mobile terminal antenna 25, the UL receiver 241 performs the radio transmitting/receiving processing on the uplink signal received by the mobile terminal antenna 25. The UL receiver 241 outputs the uplink signal subjected to the radio transmitting/receiving processing to the base station RF unit 22 through the CPU 23 or without using the CPU 23.

When transmitting the downlink signal through the mobile terminal antenna 25, the DL transmitter 242 performs the radio transmitting/receiving processing on the downlink signal output from the base station RF unit 22 through the CPU 23 or without using the CPU 23. For example, the DL transmitter 242 performs the amplifying processing on the downlink signal by the amplifier 243 provided inside thereof. The amplifier 243 performs the amplifying processing on the downlink signal according to the gain set by the DL gain control unit 234. The DL transmitter 242 outputs the downlink signal subjected to the radio transmitting/receiving processing and the amplifying processing to the mobile terminal antenna 25.

The mobile terminal antenna 25 receives the uplink signal transmitted from the mobile terminal 30 through the access link and then outputs the received uplink signal to the mobile terminal RF unit 24. The mobile terminal antenna 25 transmits the downlink signal output from the mobile terminal RF unit 24 to the mobile terminal 30 through the access link.

(3) Configuration of Control Device

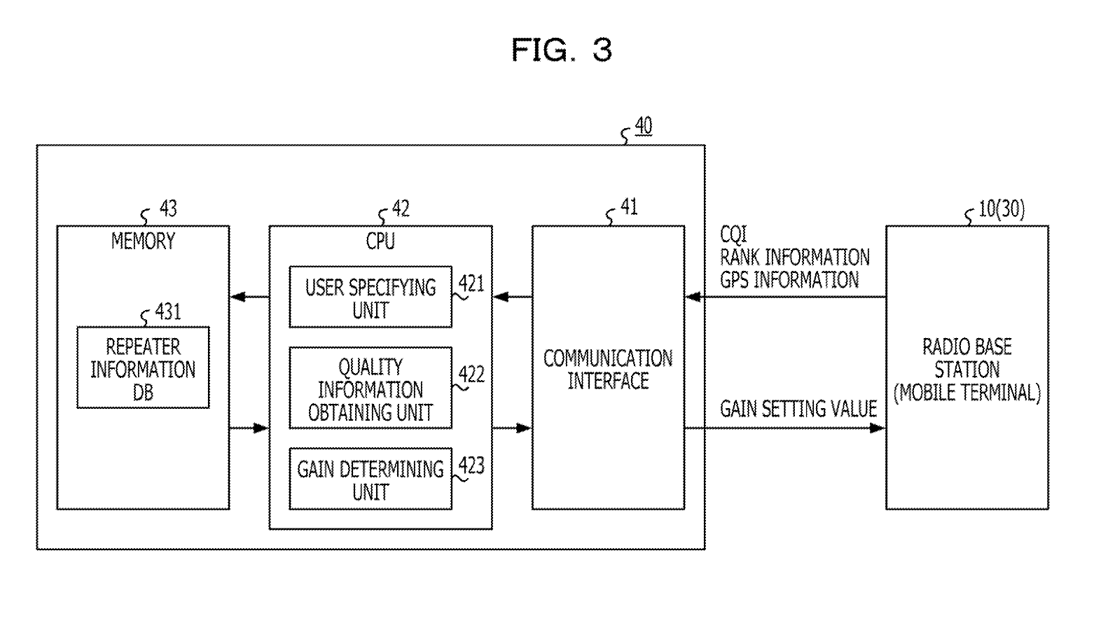

With reference to FIG. 3, a configuration of the control device 40 according to the present embodiment will be described. FIG. 3 is a block diagram illustrating the configuration of the control device 40 according to the present embodiment.

As illustrated in FIG. 3, the control device 40 includes a communication interface 41, a CPU 42, and a memory 43.

The communication interface 41 receives the various signals transmitted from the radio base station 10 to the control device 40 and then outputs the received various signals to the CPU 42. Alternatively, the communication interface 41 receives various signals transmitted from at least one of the repeater 20 and the mobile terminal 30 to the control device 40 through the radio base station 10 and then outputs the received various signals to the CPU 42. The communication interface 41 may receive the various signals directly transmitted from at least one of the repeater 20 and the mobile terminal 30 to the control device 40 without using the radio base station 10 and then may output the received various signals to the CPU 42. The communication interface 41 transmits the various signals output from the CPU 42 to the radio base station 10. Alternatively, the communication interface 41 transmits the various signals output from the CPU 42 to at least one of the repeater 20 and the mobile terminal 30 through the radio base station 10. However, the communication interface 41 may directly transmit the various signals output from the CPU 42 to at least one of the repeater 20 and the mobile terminal 30 without using the radio base station 10.

The CPU 42 is, for example, a central processing unit that controls the entire operation of the control device 40 based on the prescribed firmware. The CPU 42 includes the gain determining unit 423 as a processing block that is functional, physical, or logical and is provided inside thereof. The CPU 42 may include a user specifying unit 421 and a quality information obtaining unit 422 as a processing block that is functional, physical, or logical and is provided inside thereof.

The user specifying unit 421 specifies a user (e.g., the mobile terminal 30) that is positioned inside the relay area 29 of the repeater 20 to be controlled by the control device 40. Specifically, the user specifying unit 421 may obtain Global Positioning System (GPS) information transmitted from the mobile terminal 30 through the radio base station 10. The GPS information indicates the present position of the mobile terminal 30. On the other hand, the position of the relay area 29 of the repeater 20 is included in a repeater information Data Base (DB) 431 described below. Accordingly, by comparing the present position of the mobile terminal 30 indicated by the GPS information transmitted from the mobile terminal 30 to the position of the relay area 29 included in the repeater information DB 431, the user specifying unit 421 specifies the mobile terminal 30 positioned inside the relay area 29. The user specifying unit 421 outputs a specific result (for example, information that indicates the mobile terminal 30 positioned inside the relay area 29) to the quality information obtaining unit 422.

The quality information obtaining unit 422 obtains the reception quality of the user (e.g., the mobile terminal 30) positioned inside the relay area 29 of the repeater 20 to be controlled by the control device 40. Specifically, the quality information obtaining unit 422 obtains various communication parameters transmitted from the mobile terminal 30, which is specified by the user specifying unit 421 to be positioned inside the relay area 29, through the radio base station 10. A Channel Quality Indicator (CQI) indicating a state of the signal received by the mobile terminal 30, a Rank Indicator (RI) indicating the number of layers used for downlink transmission (determined based on a correlation of streams or a correlation of a transmission antenna and a reception antenna), and the like are given as examples of the communication parameter. Other indicators (for example, a reception power value, an error rate, and the like) may be used as the communication parameter. The quality information obtaining unit 422 calculates the reception quality of the mobile terminal 30 based on the obtained communication parameter. For example, based on at least one of the CQI and the RI as an example of the communication parameter, the quality information obtaining unit 422 may calculate an average throughput as an example of the reception quality. The quality information obtaining unit 422 outputs the obtained reception quality (for example, the average throughput) to the gain determining unit 423.

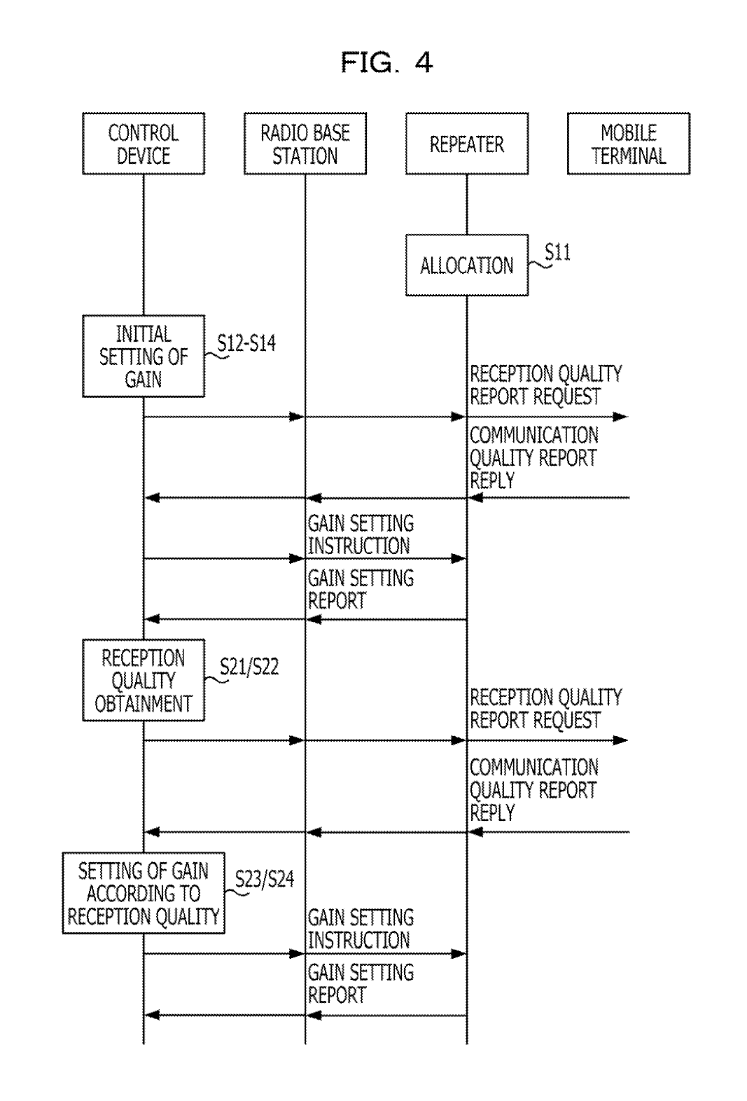

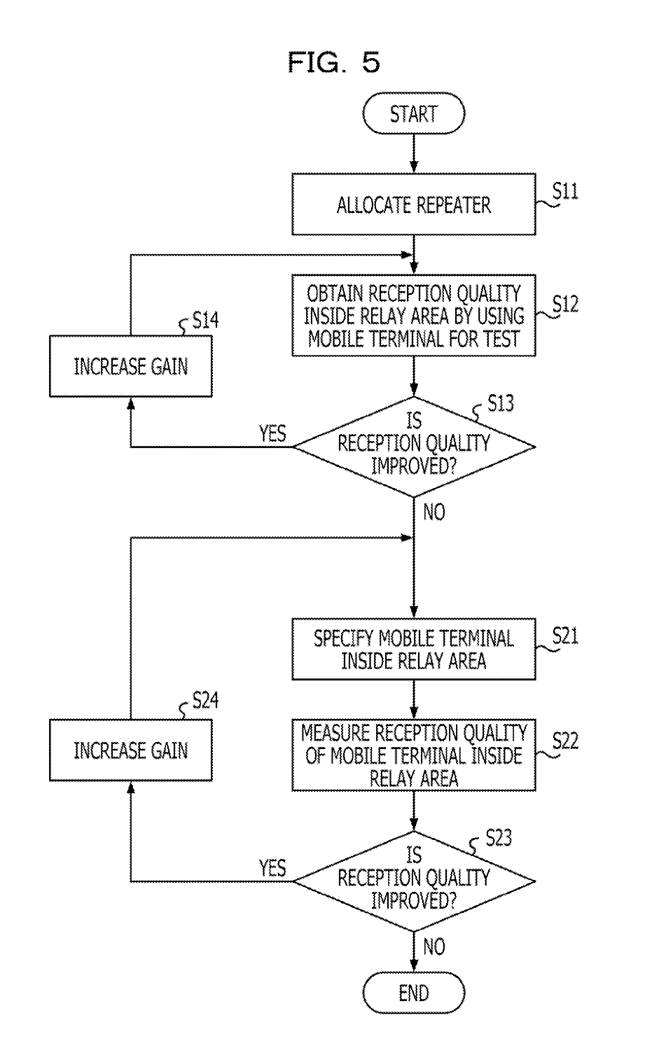

Based on the reception quality output from the quality information obtaining unit 422, the gain determining unit 423 determines each gain setting value of the amplifier 223 and the amplifier 243 included in the repeater 20. Specifically, while determining whether or not the reception quality of the mobile terminal 30 is improved, the gain determining unit 423 determines each gain setting value of the amplifier 223 and the amplifier 243 so that the reception quality is improved. The gain determining unit 423 outputs the determined gain setting value to the repeater 20 through the communication interface 41 and the radio base station 10. The determination operation of the gain setting value by the gain determining unit 423 will be described below (see FIGS. 4 and 5).

The memory 43 includes a storage area in which data to be used inside the control device 40 is temporally stored. Furthermore, the memory 43 may include a storage area or the like in which a program (that is, firmware) to be executed to perform an operation as the control device 40. For example, a semiconductor memory such as a Random Access Memory (RAM) or the like and various recording mediums are given as an example of the memory 43.

The repeater information DB 431 is stored in the memory 43. The repeater information DB 431 includes various pieces of information that specify the repeater 20 or relates to the repeater 20. For example, the repeater information DB 431 includes an identification number of the repeater 20, position information indicating the position (the range, in other words) of the relay area 29 of the repeater 20, the present gain setting value of each of the amplifier 223 and the amplifier 243 included in the repeater 20, and the like.

(4) Operation Description

With reference to FIGS. 4 and 5, an operation of the radio communication system 1 according to the present embodiment will be described. FIG. 4 is a sequence diagram illustrating an example of a flow of the operation of the radio communication system 1 according to the present embodiment. FIG. 5 is a flowchart illustrating an example of the flow of the operation of the radio communication system 1 according to the present embodiment.

As illustrated in FIGS. 4 and 5, if another repeater 20 is newly allocated to compensate the cell 19 of the radio base station 10 (Operation S11), the control device 40 performs initial setting of each gain of the amplifier 223 and the amplifier 243 included in the repeater 20. When the repeater 20 is newly allocated, each gain of the amplifier 223 and the amplifier 243 included in the repeater 20 may be set to a default setting value (for example, a relatively low setting value).

Specifically, inside the relay area 29 of the repeater 20 that is newly allocated, an operator such as a communication carrier allocates the mobile terminal 30 for test used for initial setting of the gain, for example, is allocated inside the relay area 29.

The quality information obtaining unit 422 included in the control device 40 transmits a reception quality report request message, which requests a report of the above-described communication parameter, to the mobile terminal 30 for test through at least one of the radio base station 10 and the repeater 20. After receiving the reception quality report request message, the mobile terminal 30 for test measures the above-described communication parameter (for example, the CQI and the RI). After that, the mobile terminal 30 for test transmits a reception quality report reply message that reports the measured communication parameter to the control device 40 through at least one of the radio base station 10 and the repeater 20.

The quality information obtaining unit 422 included in the control device 40 receives the reception quality report reply message transmitted from the mobile terminal 30 for test. As a result, the quality information obtaining unit 422 obtains the communication parameter. After that, based on the communication parameter transmitted from the mobile terminal 30 for test, the quality information obtaining unit 422 obtains (calculates, in other words) the reception quality of the mobile terminal 30 for test (Operation S12). If a plurality of the mobile terminals 30 for test is allocated inside the relay area 29, Operation S12 may be performed on either each or some of the mobile terminals 30.

The mobile terminal 30 for test is allocated inside the relay area 29 by the operator. Therefore, to perform the initial setting of the gain by using the mobile terminal 30 for test, the mobile terminal 30 may be unlikely to be specified by the user specifying unit 421. The quality information obtaining unit 422 may obtain all the communication parameters, which are to be transmitted, without determining whether or not the mobile terminal 30 is positioned inside the relay area 29.

The gain determining unit 423 included in the control device 40 determines whether or not the reception quality of the mobile terminal 30 obtained this time is improved compared to the reception quality obtained in the previous time (Operation S13). For example, the gain determining unit 423 determines whether or not the average throughput of the mobile terminal 30 obtained this time is improved (that is, increased) compared to the average throughput obtained in the previous time. The average throughput of the mobile terminal 30 increases if there is a better balance between a reception power in the mobile terminal 30 of the signal transmitted from the radio base station 10 through the direct link and the reception power in the mobile terminal 30 of the signal transmitted from the repeater 20 through the access link. Therefore, in addition to or instead of determining whether or not the reception quality is improved, the gain determining unit 423 may determine whether or not there is a balance between the reception power in the mobile terminal 30 of the signal transmitted from the radio base station 10 through the direct link and the reception power in the mobile terminal 30 of the signal transmitted from the repeater 20 through the access link. In other words, the gain determining unit 423 may determine whether or not a rate between the reception power in the mobile terminal 30 of the signal transmitted from the radio base station 10 through the direct link and the reception power of the mobile terminal 30 of the signal transmitted from the repeater 20 through the access link has a desired value or is within a desired range.

Based on the determination result in Operation S13, if the reception quality of the mobile terminal 30 obtained this time is improved compared to the reception quality obtained in the previous time (YES in Operation S13), the reception quality is assumed to be improved by adjusting the gain. Accordingly, the gain determining unit 423 determines another gain setting value obtained by adding a prescribed amount of increase to the present gain setting value (Operation S14).

After that, the gain determining unit 423 transmits a gain setting instruction message, which includes the gain setting value determined in Operation S14, to the repeater 20 through the radio base station 10. The gain control information detecting unit 232, which is included in the repeater 20 that received the gain setting instruction message, extracts the gain setting value included in the gain setting instruction message. After that, the UL gain control unit 233 sets the gain of the amplifier 223 to the extracted gain setting value (specifically, the gain setting value with respect to the amplifier 223). Similarly, the DL gain control unit 234 sets the gain of the amplifier 243 to the extracted gain setting value (specifically, the gain setting value with respect to the amplifier 243). After that, the repeater 20 transmits the gain setting report message, which reports that the setting of each gain of the amplifier 223 and the amplifier 243 based on the gain setting value is completed, to the control device 40 through the radio base station 10.

After that, the operation following Operation S12 is repeated.

Based on the determination result in Operation S13, if the reception quality of the mobile terminal 30 obtained this time is not improved compared to the reception quality obtained in the previous time (NO in Operation S13), the reception quality is assumed to be unable to be improved by adjusting the gain. That is, the reception quality is assumed to be preferably improved or sufficiently improved by adjusting the gain. The gain determining unit 423 ends the operation.

When the control device 40 controls the plurality of repeaters 20, the operation from Operation S12 to Operation S14 is preferably performed in each of the repeaters 20.

The above-described operation is equivalent to the initial operation that is performed at a timing when the repeater 20 is newly allocated. A steady operation performed in an operation state after allocation of the repeater 20 will be described below. Even if the repeater 20 is newly allocated, the steady operation may be performed without the initial operation.

As illustrated in FIGS. 4 and 5, based on the GPS information transmitted from the mobile terminal 30 and on the position of the relay area 29 included in the repeater information DB 431, the user specifying unit 421 included in the control device 40 specifies the mobile terminal 30 positioned inside the relay area 29 of the repeater 20 to be controlled (Operation S21).

Based on the communication parameter transmitted from the mobile terminal 30 positioned inside the relay area 29, the quality information obtaining unit 422 included in the control device 40 calculates to obtain the reception quality of the mobile terminal 30 positioned inside the relay area 29 (Operation S22). The operation S22 may be equivalent to Operation S12 described above.

The gain determining unit 423 included in the control device 40 determines whether or not the reception quality of the mobile terminal 30 obtained this time is improved compared to the reception quality obtained in the previous time (Operation S23). For example, the gain determining unit 423 determines whether or not the average throughput of the mobile terminal 30 obtained this time is improved (that is, increased) compared to the average throughput obtained in the previous time. Operation S23 may be equivalent to Operation S13 described above.

Based on the determination result in Operation S23, if the reception quality of the mobile terminal 30 obtained this time is improved compared to the reception quality obtained in the previous time (Yes in Operation S23), the reception quality is assumed to be improved by adjusting the gain. Accordingly, the gain determining unit 423 determines a new gain setting value obtained by adding the prescribed amount of increase to the present gain setting value (Operation S24). Operation S24 may be substantially equivalent to Operation S14 described above.

After that, the gain determining unit 423 transmits the gain setting instruction message, which includes the gain setting value determined in Operation S24, to the repeater 20 through the radio base station 10. After receiving the gain setting instruction message, the gain control information extracting unit 232 included in the repeater 20 extracts the gain setting value included in the gain setting instruction message. After that, the UL gain control unit 233 sets the gain of the amplifier 223 to the extracted gain setting value (specifically, the gain setting value with respect to the amplifier 223). Similarly, the DL gain control unit 234 sets the gain of the amplifier 243 to the extracted gain setting value (specifically, the gain setting value with respect to the amplifier 243). After that, the repeater 20 transmits the gain setting report message, which indicates that the setting of each gain of the amplifier 223 and the amplifier 243 is completed based on the gain setting value, to the control device 40 through the radio base station 10.

After that, the operation following Operation S21 is repeated.

On the other hand, based on the determination result from Operation S23, if the reception quality of the mobile terminal 30 obtained this time is not improved compared to the reception quality obtained in the previous time (NO in Operation S23), the reception quality is assumed to be unable to be improved any more by adjusting the gain. That is, the reception quality is assumed to be improved to the maximum by adjusting the gain. Therefore, the gain determining unit 423 ends the operation.

If the control device 40 controls a plurality of repeaters 20, the operation from Operation S21 to Operation S24 may be performed with respect to each repeater 20.

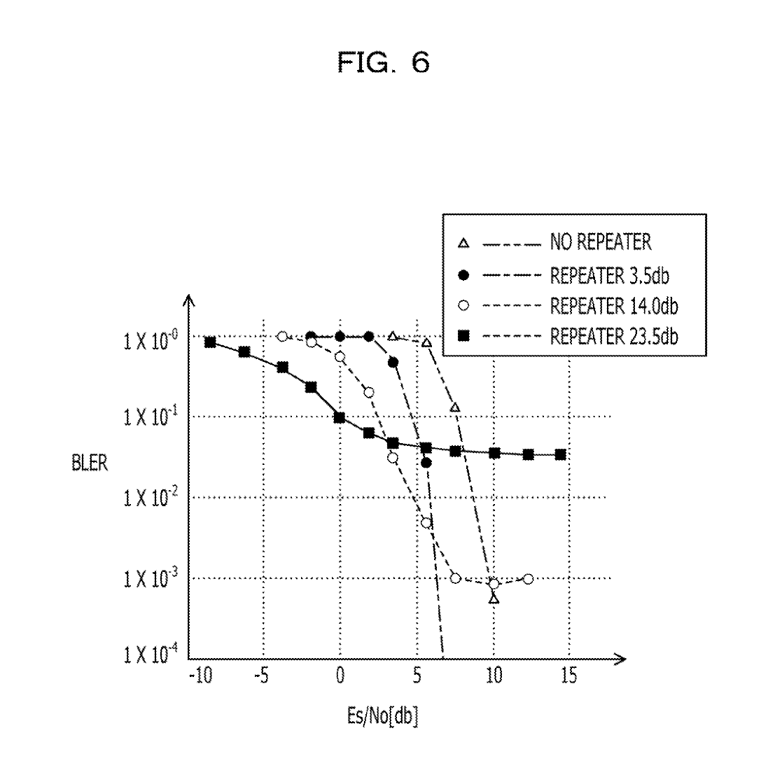

With reference to FIG. 6, the improvement of the reception quality of the mobile terminal 30 obtained by the determination of the gain setting value by the gain determining unit 423 is shown. FIG. 6 is a graph illustrating improvement of the reception quality of the mobile terminal 30 that is obtained by determining the gain setting value by the gain determining unit 423.

By using white triangles and a long dashed double-short dashed line, FIG. 6 illustrates a characteristic of Block Error Rate (BLER) to the reception quality of the mobile terminal 30 in a case where the repeater 20 does not exist. By using black circles and a double dotted line, FIG. 6 illustrates a characteristic of the BLER to the reception quality of the mobile terminal 30 in a case where the reception power of the signal transmitted from the repeater 20 through the access link is higher than the reception power of the signal transmitted from the radio base station 10 through the direct link by 3.5 dB. By using white triangles and a dotted line, FIG. 6 illustrates a characteristic of the BLER to the reception quality of the mobile terminal 30 in a case where the reception power of the signal transmitted from the repeater 20 through the access link is higher than the reception power of the signal transmitted from the radio base station 10 through the direct link by 14.0 dB. By using black triangles and a solid line, FIG. 6 illustrates a characteristic of the BLER to the reception quality of the mobile terminal 30 in a case where the reception power of the signal transmitted from the repeater 20 through the access link is higher than the reception power of the signal transmitted from the radio base station 10 through the direct link by 23.5 dB. The smaller Es/No indicating S/N per symbol, the larger the average throughput is. Accordingly, the graph illustrated in FIG. 6 may be handled as a graph indicating the average throughput as the reception quality of the mobile terminal 30.

For example, in an area specified by BLER=1×10⁻¹, if the reception quality is improved if each gain of the amplifier 223 and the amplifier 243 is increased, the reception quality is improved (specifically, Es/No becomes small, that is, the average throughput is increased). Specifically, if each gain of the amplifier 223 and the amplifier 243 included in the repeater 20 is increased in such a way that the reception power of the signal transmitted from the repeater 20 through the access link becomes higher by 3.5 dB, the improvement of the reception quality by approximately 3 dB is achieved compared to the reception quality of the mobile terminal 30 in a case where the repeater 20 does not exist. Similarly, if each gain of the amplifier 223 and the amplifier 243 included in the repeater 20 is increased in such a way that the reception power of the signal transmitted from the repeater 20 through the access link becomes higher by 14.0 dB, the improvement of the reception quality by approximately 5 dB is achieved compared to the reception quality of the mobile terminal 30 in a case where the repeater 20 does not exist. If each gain of the amplifier 223 and the amplifier 243 included in the repeater 20 is improved so that the reception power of the signal transmitted from the repeater 20 through the access link becomes higher by 23.5, the improvement of the reception quality by approximately 7.5 dB is achieved compared to the reception quality of the mobile terminal 30 in a case where the repeater 20 does not exist. Therefore, the reception quality of the mobile terminal 30 is improved by the above-described determination operation (that is, the operation for increasing the gain while monitoring the reception quality) of the gain setting value by the gain determining unit 423. If each gain of the amplifier 223 and the amplifier 243 included in the repeater 20 is increased so that the reception power of the signal transmitted from the repeater 20 through the access link increases, the floor of the BLER increases and does not satisfy BLER=1×10⁻¹. Therefore, the increase of the gain of the amplifier 223 and the amplifier 243 may be limited.

On the other hand, when each gain of the amplifier 223 and the amplifier 243 included in the repeater 20 is increased, the floor of the BLER is increased. If the floor of the BLER is excessively increased (for example, increased more than 1×10⁻¹), the average throughput is decreased. Therefore, by increasing the gain while monitoring whether or not the average throughput is improved, each gain of the amplifier 223 and the amplifier 243 may be determined while improving the reception power and substantially suppressing the excessive increase of the floor of the BLER.

The increase of the floor of the BLER may be generated if there is not a balance between the reception power of the signal transmitted from the radio base station 10 through the direct link and the reception power of the signal transmitted from the repeater 20 through the access link (that is, the rate of the reception powers does not have a desired value or is not set in a desired range). In other words, if there is a balance between the reception power of the signal transmitted from the radio base station 10 through the direct link and the reception power of the signal transmitted from the repeater 20 through the access link (that is, if the rate of the reception powers has the desired value or is in the desired range), the floor of the BLER is unlikely to be increased. Therefore, by increasing the gain while monitoring whether or not the average throughput is improved, the reception quality may be improved and excessive increase of the floor of the BLER may be substantially suppressed. As a result, there is a balance between the reception power of the signal transmitted from the radio base station 10 through the direct link and the reception power of the signal transmitted from the repeater 20 through the access link (that is, the rate of the reception powers has a desired value or is set in a desired range).

As described above, the control device 40 according to the present embodiment may increase each gain of the amplifier 223 and the amplifier 243 included in the repeater 20 while monitoring whether or not the reception quality of the mobile terminal 30 is improved (for example, the average throughput). Therefore, compared to the radio communication system that does not monitor whether or not the reception quality of the mobile terminal 30 is improved, the radio communication system 1 according to the present embodiment may preferably determine each gain of the amplifier 223 and the amplifier 243 included in the repeater 20. As a result, the repeater 20 may preferably perform the relay of the radio communication between the radio base station 10 and the mobile terminal 30.

The control device 40 according to the present embodiment may control the repeater 20 while optimizing the reception quality of the mobile terminal 30. Accordingly, the control device 40 according to the present embodiment may change an area outside the range into an area inside the range while optimizing the reception quality of the mobile terminal 30.

In addition, the control device 40 according to the present embodiment may optimize the reception quality of the mobile terminal 30 inside the area even if the area is inside the range. Therefore, the radio communication system 1 according to the present embodiment may improve the reception quality in the area inside the range.

When the radio base station 10 and the mobile terminal 30 include a plurality of antennas, the MIMO communication may be performed inside the cell 19 of the radio base station. However, in the vicinity of an edge of the cell 19, the MIMO communication may not be performed (in other words, simply the SISO communication is performed) due to decrease of Signal to Interference Ration (SIR) or of the RI. The control device 40 according to the present embodiment may determine each gain of the amplifier 223 and the amplifier 243 included in the repeater 20 so that the reception quality (for example, the average throughput) of the mobile terminal 30 becomes optimum. Therefore, in the radio communication system 1 according to the present embodiment, the radio base station 10 and the mobile terminal 30 may perform the MIMO communication as the average throughput is increased in the area where simply the SISO communication is performed unless the repeater 20 is positioned. That is, the radio communication system 1 according to the present embodiment may change the area where the MIMO communication may not be performed (in other words, simply the SISO communication may be performed) into an area where the MIMO communication may be performed.

Moreover, in the radio communication system 1 according to the present embodiment, the area in which the MIMO communication may not be performed is changed, by the repeater 20 having the single mobile terminal antenna 25 (or the single base station antenna 21), into an area in which the MIMO communication may be performed. In other words, in the radio communication system 1 according to the present embodiment, the area in which the MIMO communication may not be performed is changed, by not only the repeater 20 having a plurality of base station antennas 25 (or a plurality of base station antennas 21), but may be changed into the area in which the MIMO communication may be performed. Due to this, the cost of the repeater 20 may be reduced to achieve the above-described various effects.

The control device 40 according to the present embodiment may monitor the reception quality (for example, the average throughput) based on the CQI and the RI. Therefore, the control device according to the present embodiment may properly monitor the reception quality.

The control device 40 according to the present embodiment may obtain the reception quality of the mobile terminal 30 positioned inside the relay area 29. Therefore, the control device 40 according to the present embodiment may optimize the reception quality of the mobile terminal positioned inside the relay area 29 of the repeater 20 to be controlled.

When a plurality of mobile terminals 30 is positioned inside the relay area 29, the control device 40 according to the present embodiment may obtain each reception quality of the plurality of mobile terminals 30. Therefore, since the number of monitor samples of the reception quality is increased, the control device 40 according to the present embodiment may optimize the reception quality of the mobile terminal 30 positioned inside the relay area 29 of the repeater 20 to be controlled.

Based on the GPS information transmitted from the mobile terminal 30, the control device 40 according to the present embodiment may determine whether or not the mobile terminal 30 is positioned inside the relay area 29. Therefore, the control device 40 according to the present embodiment may obtain the reception quality of the mobile terminal 30 positioned inside the relay area 29.

The above-description illustrates, for example, each gain of the amplifier 223 and the amplifier 243 included in the repeater 20. However, in addition to or instead of the adjustment of each gain of the amplifier 223 and the amplifier 243 included in the repeater 20, at least one of the antenna parameters of the base station antenna 21 and the mobile terminal antenna 25 included in the repeater 20 may be adjusted. A tilt angle, a beam direction, a beam width, and the like are given as examples of the antenna parameter. In the above-described configuration, the above-described various effects may be achieved.

In the above-description, in consideration of allocation of the repeater 20 for the improvement of the throughput inside the cell 19, the operation of the repeater 20 is described by using behaviors under the single cell 19. On the other hand, according to the allocation state of the repeater 20, the repeater 20 may generate interference with respect to another cell 19 other than the cell 19 in which the repeater 20 is allocated. For example, as in the example illustrated in FIG. 1, the repeater 20a allocated in the cell 19a may generate the interference with respect to the adjacent cell 19b. In this case, the gain of the amplifier 223 and the amplifier 243 is preferable to be adjusted so that the interference with respect to another cell 19 is not increased. In this case, the interference state of the plurality of cells 19 may be monitored. Therefore, the configuration of the control device 40 that controls the plurality of base stations 10 illustrated in FIG. 10 is effective. Alternatively, the interference amount may be transmitted and received between the adjacent radio base stations 10 (for example, between the radio base station 10a and the radio base station 10b). By the above-described correction, the gain control of the repeater 20 in consideration of the interference to the other cell 19 may be achieved.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A radio communication system comprising:
a first communication device configured to transmit a signal;
a relay device which includes a receiver configured to receive the transmitted signal, an amplifier configured to amplify the received signal according to a gain determined by a processor included in a control device, and a transmitter configured to transmit the amplified signal to a second communication device;
the second communication device being configured to receive the amplified signal, and the transmitted signal, which is transmitted directly from the first communication device; and
the control device being configured to improve a reception quality of the amplified signal and the directly transmitted signal in the second communication device.

2. The radio communication system according to claim 1, wherein the first communication device transmits the signal by different data streams by using a plurality of antennas, and
wherein the second communication device separates the amplified signal into the different data streams by receiving, by the plurality of antennas, the amplified signal, and the transmitted signal, which is transmitted directly from the first communication device.

3. The radio communication system according to claim 2, wherein the processor determines the gain of the amplifier so that a Multiple Input Multiple Output (MIMO) communication, which includes transmission of the signal using the plurality of antennas by the first communication device and reception of the transmitted signal using the plurality of antennas, is maintained.

4. The radio communication system according to claim 1, wherein the first communication device transmits the signal in a single data stream by using a single antenna, and
wherein the second communication device receives the transmitted single data stream by using the single antenna.

5. The radio communication system according to claim 1, wherein the reception quality is calculated based on at least one of a Channel Quality Indicator (CQI) and a Rank Indicator (RI).

6. The radio communication system according to claim 5, wherein the reception quality includes an average throughput calculated based on at least one of the CQI and the RI, and
wherein the processor determines the gain of the amplifier so that the average throughput becomes maximum.

7. The radio communication system according to claim 1, wherein the processor determines the gain of the amplifier so that the reception quality in the second communication device is improved by setting a rate between the reception power of the amplified signal and the reception power of the transmitted signal, which is transmitted directly from the first communication device, in a prescribed range.

8. The radio communication system according to claim 1, wherein the processor obtains the reception quality of the second communication device positioned inside a relay area of the relay device, and
wherein the processor determines the gain of the amplifier so that the reception quality in the second communication device of the amplified signal, the transmitted signal, which is transmitted directly from the first communication device, and the reception quality obtained by the processor are improved.

9. The radio communication system according to claim 1, wherein the processor obtains the reception quality of each of a plurality of second communication devices positioned inside a relay area of the relay device and determines the gain of the amplifier so that the reception quality of the amplified signal of each of the plurality of second communication devices and the transmitted signal, which is transmitted directly from the first communication device, and the obtained reception quality are improved.

10. The radio communication system according to claim 8, wherein the processor obtains a portion of position information indicating a position of the second communication device, specifies the second communication device positioned inside the relay area based on the obtained position information, and obtains the reception quality of the specified second communication device.

11. A relay device comprising:
a receiver configured to receive a signal transmitted from a first communication device;
an amplifier configured to amplify the received signal according to a gain that is determined so that a reception quality in a second communication device is improved when the second communication device receives the amplified signal and the transmitted signal, which is transmitted directly from the first communication device; and
a transmitter which transmits the amplified signal to the second communication device.

12. A control device comprising:
a processor configured to perform processing to determine a gain of an amplifier, included in a relay device that receives a signal transmitted from a first communication device, amplifies the transmitted signal, and transmits the amplified signal to a second communication device, so that a reception quality in the second communication device is improved when the second communication device receives the amplified signal and transmitted signal, which is transmitted directly from the first communication device.

13. A communication method, comprising:
receiving, by a relay device, a signal transmitted from a first communication device;
amplifying the received signal by an amplifier included in the relay device;
transmitting the amplified signal from the relay device to a second communication device;
receiving, by the second communication device, the amplified signal and the transmitted signal, which is transmitted directly from the first communication device; and
determining a gain of the amplifier so that the reception quality in the second communication device is improved when the second communication device receives the amplified signal and the transmitted signal, which is transmitted directly from the first communication device.
